(19) United States
(12) Patent Application Publication
(10) Pub. No.: US 2009/0271319 A1
(43) Pub. Date: Oct. 29, 2009

(54) Embedded Licenses for Content

(75) Inventors: Dennis N. Bromley, Issaquah, WA (US); Sumedh N. Barde, Redmond, WA (US); Clifford P. Strom, Sammamish, WA (US); Angelika J. Kinneman, Sammamish, WA (US); David L. Chilton, Seattle, WA (US); Pankaj Sethi, Seattle, WA (US); Shalendra Chhabra, Kirkland, WA (US); Quintin S. Burns, Fort Mills, SC (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/111,199

(22) Filed: Apr. 29, 2008

(51) Int. Cl. H04L 1/00

(52) U.S. Cl. 705/59

(57) ABSTRACT

In accordance with one or more aspects, a license for content is retrieved, the license having been previously embedded in the content. A requested action is allowed to be performed with the content only if a standalone license, or both a leaf license and a root license, indicate that the action with the content is permissible. Leaf licenses and/or standalone licenses can be embedded by a source of the content and/or by a target device that receives the content. Additionally, licenses can include one or more rules indicating where a target device that receives the content is to store the licenses.

### BACKGROUND

The storage and playback of different types of audio and/or video content is increasingly being performed digitally, with various computers and other digital devices being used for playback. In order to protect their content and ensure only those who have acquired rights to use the content can indeed use the content, content is frequently encrypted using a cryptographic key. However, one problem with this encryption is that the cryptographic key is typically associated with a particular device. This can make it difficult for a user to playback the content on other devices that he or she owns even though he or she has acquired rights to use the content.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects of the embedded licenses for content, a request to perform an action with content is received. A license for the content is retrieved, the license having been previously embedded in the content. This license is a license for a domain that includes one or more devices including the device that received the request. The action is allowed to be performed with the content if the license indicates that the action with the content is permissible, and otherwise the action is prevented from being performed with the content.

In accordance with one or more aspects of the embedded licenses for content, content to be sent to a second device is accessed. A check is made as to whether the content already has an embedded license for a domain of which the second device is a part. If the content already has the embedded license for the domain, then the content is sent with the embedded license to the second device. If the content does not already have the embedded license for the domain, then a license for the domain is embedded in the content, and the content is sent with the embedded license to the second device.

In accordance with one or more aspects of the embedded licenses for content, a request for a license to access content is received from a device. The requested license is sent to the device, the requested license including one or more rules indicating where the device is to store the license.

### BRIEF DESCRIPTION OF THE DRAWINGS

The same numbers are used throughout the drawings to reference like features.

FIG. 1 illustrates an example system implementing embedded licenses for content in accordance with one or more embodiments.

FIG. 2 illustrates example content having an embedded license portion in accordance with one or more embodiments.

FIG. 3 is a flowchart illustrating an example process for using content having embedded licenses in accordance with one or more embodiments.

FIG. 4 is a flowchart illustrating an example process for using chains of licenses in accordance with one or more embodiments.

FIG. 5 is a flowchart illustrating an example process for embedding licenses at a source device in accordance with one or more embodiments.

FIG. 6 is a flowchart illustrating an example process for using embedded license rules in accordance with one or more embodiments.

FIG. 7 illustrates an example computing device that can be configured to implement embedded licenses for content in accordance with one or more embodiments.

### DETAILED DECRIPTION

Embedded licenses for content are discussed herein. Generally, licenses for content are embedded in the content, allowing the licenses to easily be sent to various devices along with the content. The content includes an embedded license portion in which one or more embedded licenses can be stored. Each embedded license can be a standalone license or part of a chain of licenses. Additionally, each embedded license can be associated with a particular device or a domain of which one or more devices are a part. The licenses can be embedded by a device that receives the content, or alternatively by the device from which the content is received. Additionally, a license can include one or more rules regarding where devices are to store the license.

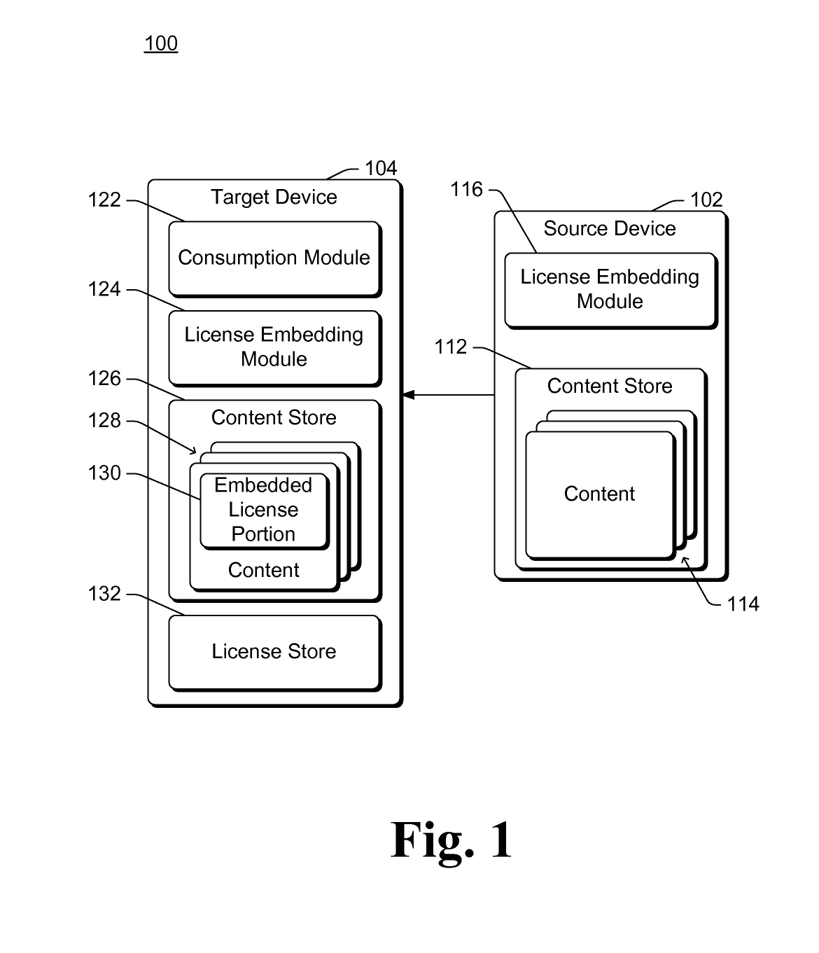

FIG. 1 illustrates an example system 100 implementing the embedded licenses for content in accordance with one or more embodiments. System 100 includes a source device 102 and a target device 104. Content can be transferred from source device 102 to target device 104 in a variety of different manners. In one or more embodiments, content is transferred via a network, such as the Internet, a local area network (LAN), a public telephone network, an intranet, other public and/or proprietary networks, combinations thereof, and so forth. In other embodiments, content is transferred via a direct wired or wireless connection, such as a Universal Serial Bus (USB) connection, an IEEE 1394 compliant connection, a wireless USB connection, a Bluetooth connection, and so forth. It is to be appreciated that content can also be transferred using one or more transport devices, such as a magnetic disk, optical disc, USB dongle, and so forth.

Each of source device 102 and target device 104 can be a variety of different devices capable of playing, storing, or otherwise using content. Source device 102 and target device 104 can both be the same types of devices, or alternatively can be different types of devices. For example, each of devices 102 and 104 can be a desktop computer, a server computer, a mobile station, an entertainment appliance, a set-top box communicatively coupled to a display device, a wireless phone, a game console, an automotive computer, a kiosk, and so forth. Thus, each of devices 102 and 104 may range from a full resource device with substantial memory and processor resources (e.g., personal computers, game consoles) to a low-resource device with limited memory and/or processing resources (e.g., traditional set-top boxes, hand-held game consoles).

Devices 102 and/or 104 can generally access and/or use content in different manners, such as perform one or more of play the content, store the content, transfer the content, and so forth. Content as used herein refers to a variety of different digital or electronic content, such as audio content (e.g., songs), audio/video content (e.g., television shows, movies, documentaries, cartoons, etc.), image content (e.g., digital pictures), text content (e.g., electronic books), compiled or uncompiled computer programs or portions thereof, Java games, zipped or otherwise compressed files, email messages and attachments, and so forth, as well as combinations thereof. Whether particular content can be accessed by a particular device 102 and/or 104 is determined based at least in part on an embedded license for that particular content, as discussed in more detail below.

Source device 102 includes a content store 112 including content 114, and a license embedding module 116. In one or more embodiments, license embedding module 116 embeds licenses in content 114 prior to transferring the content to target device 104. In other embodiments, licenses are embedded by target device 104. This embedding of licenses in content is discussed in more detail below.

Target device 104 includes a consumption module 122, license embedding module 124, and content store 126. Content store 126 includes content 128. Each of the content 128 (e.g., each song, each movie, etc.) includes an embedded license portion 130. Consumption module 122 manages the consumption of content 128 at target device 104. How particular content 128 is consumed can vary based on a particular request received from a user to use content 128 as well as the type of content 128. For example, this consumption can include playback of content 128, transferring content 128 to another device, burning content 128 to a CD (compact disc) or other optical disc, printing a hard copy of content 128, emailing content 128, and so forth. In one or more embodiments, license embedding module 124 embeds licenses into embedded license portion 130 of content 128, as discussed in more detail below. Additionally, in one or more embodiments target device 104 includes a license store 132 in which one or more licenses for content 128 are stored.

References are made herein to symmetric key cryptography, public key cryptography and public/private key pairs. Although such key cryptography is well-known to those skilled in the art, a brief overview of such cryptography is included here to assist the reader. In public key cryptography, an entity (such as a hardware or software component, a device, a domain, and so forth) has associated with it a public/private key pair. The public key can be made publicly available, but the entity keeps the private key a secret. Without the private key it is computationally very difficult to decrypt data that is encrypted using the public key. So, data can be encrypted by any entity with the public key and only decrypted by an entity with the corresponding private key. Additionally, a digital signature for data can be generated by using the data and the private key. Without the private key it is computationally very difficult to create a signature that can be verified using the public key. Any entity with the public key can use the public key to verify the digital signature by comparing a verification value obtained using the public key with the original data, and if the two are the same then be assured that no one has tampered with or altered the data that was digitally signed.

In symmetric key cryptography, on the other hand, a shared key is known by and kept secret by the two entities. Any entity having the shared key is typically able to decrypt data encrypted with that shared key. Without the shared key it is computationally very difficult to decrypt data that is encrypted with the shared key. So, if entity A and entity B both know the shared key, each can encrypt data that can be decrypted by the other, but other entities cannot decrypt the data if the other entities do not know the shared key.

Consumption module 122 enforces digital rights management (DRM) on target device 104. Digital rights management refers to the protection of the rights of the artists, publishers, and/or copyright owners of digital content. The DRM techniques employed by consumption module 122 restrict actions that can be taken with content 128 on target device 104. A variety of different accesses can be restricted, such as playback of content 128, burning content 128 to a CD or other optical disc, copying content 128 to another device, printing a hard copy of content 128, sending content 128 via email, and so forth.

The DRM techniques are employed by consumption module 122 to protect content 128 from improper uses or actions on target device 104. The constraints on the use of content 128 are made known to device 104, typically as part of a license as discussed in more detail below. Alternatively, one or more constraints could be made known in other manners, such as pre-programmed into consumption module 122, separate notification being given of the constraints (e.g., a separate message sent to device 104, or obtaining the constraints from a web site, etc.), and so forth.

Content 128 is typically protected by being encrypted so that content 128 can only be consumed in an intelligible manner if the proper decryption key is known. Consumption module 122 employs various DRM techniques to determine when it is permissible to decrypt the content (in accordance with the constraints on the use of content 128). The DRM techniques can be implemented in a variety of different manners. For example, the DRM techniques can include verification that the operating system and/or other software executing on device 104 is trustworthy, verification that the constraints dictated by the owner of the copyright of content 128 and/or the distributor of content 128 have been satisfied, verification that the operating system and/or device 104 has the latest DRM updates as required by one or more licenses, and so forth. Various different DRM techniques are known to those skilled in the art, and one or more of such techniques can be used by consumption module 122.

One or more constraints on the use of particular content 128 are identified based on one or more licenses corresponding to that particular content 128. A license for particular content 128 includes both a policy identifying when it is permissible to decrypt the particular content 128 and a cryptographic key for decrypting the particular content 128. This cryptographic key is often times a shared key used with symmetric key encryption, although can alternatively be a private key used with public key encryption.

The policy identifies one or more actions that can be taken with the corresponding content 128, one or more parties that can take those one or more actions, and/or one or more constraints or conditions to be satisfied in order to take those actions. Alternatively, or in addition, the policy can identify one or more actions that cannot be taken with corresponding content 128, and/or one or more parties that cannot take one or more actions. Examples of actions that can be taken (or alternatively cannot be taken) include playback of the corresponding content 128, burning the corresponding content 128 to a CD or other optical disc, copying the corresponding content 128 to another device, printing a hard copy of content 128, emailing content 128, and so forth. Examples of parties that can take (or alternatively cannot take) such actions include a particular target device 104, a particular user of target device 104, and so forth. Examples of constraints or conditions to be satisfied include a particular consumption module 122 running on target device 104, a particular operating system running on target device 104, and so forth.

A variety of different licenses can be used. For example, one license may indicate that a particular target device 104 can playback particular content 128 but cannot burn that particular content 128 to a CD. By way of another example, another license may indicate that a particular target device 104 can playback particular content 128, burn that particular content 128 to a CD, and transfer that particular content 128 to another device.

Licenses can be associated with a particular target device or with a particular domain. When associated with a particular target device, the policy of the license indicates that actions can only be taken by that particular target device. Any attempt to use the license on a different target device will result in the requested action being denied. On the other hand, when associated with a particular domain, the policy of the license indicates that actions can only be taken by any target device that is part of (or a member of) that domain. One or more individual target devices can register to become part of that domain, or alternatively a user can register to become part of a domain. Any attempt to use the license on a target device that is not part of the domain will result in the requested action being denied. For example, a user could own multiple target devices and register all those devices as part of a single domain, and all those devices could playback content having a license indicating that a device that is part of that domain can playback the content.

The content 128 is typically encrypted using a cryptographic key included in the license associated with the content 128. The consumption module 122 extracts this key from the license and uses it to decrypt the content only if the policy in the license indicates that consumption module 122 is permitted to use the content. The key in the license is bound to a particular target device 104 or domain, such as by using the public key of the particular target device 104 or domain to encrypt the key in the license (or alternatively to encrypt the entire license). Thus, only the particular target device 104 or domain to which the key in the license is bound can extract and use the key to decrypt the content.

Each particular content 128 in content store 126 has an embedded license portion 130 in which one or more embedded licenses can be stored. An embedded license refers to a license that is embedded in the content rather than being a separate file (e.g., on-disk, in-memory, or elsewhere). Embedding licenses in content 128 allows licenses for content 128 to be easily transferred to other devices. For example, a file that contains particular content 128 can also contain embedded licenses for that particular content 128. Content 128, including any embedded licenses, can be transferred to other devices without requiring any check as to whether an embedded license allows the device receiving content 128 to consume the content 128. Rather, the content 128 can be easily transferred to the receiving device, and if a license indicates that the receiving device is allowed to consume the content then the receiving device will be allowed to consume the content.

Generally, licenses which are portable in nature are embedded in content 128, whereas licenses which are not portable in nature are not embedded in content. For a license to be portable in nature, the license is typically associated with either a domain or a root license. Standalone licenses that are bound to a specific target device 104 are typically not usable on another device, and thus are generally not portable in nature and are generally not embedded in content 128.

Licenses obtained by target device 104 can be copied among various license stores. The licenses can be embedded in content 128 in embedded license portions 130, so embedded license portions 130 can be viewed as one license store. A device license store 132 can also be included in target device 104, and one or more other license stores (not shown) on other devices (not shown) coupled to target device 104 can also store licenses. Licenses can be copied among these various license stores by consumption module 122 or alternatively by another module implementing the DRM for target device 104.

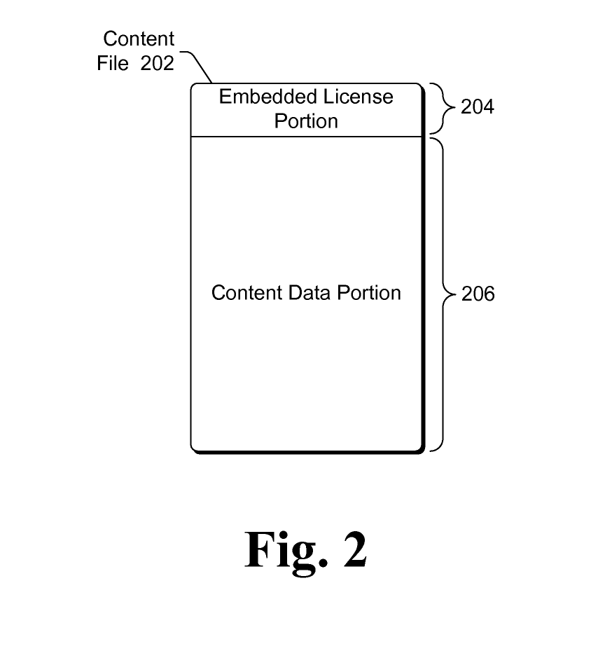

FIG. 2 illustrates example content having an embedded license portion. In FIG. 2, content file 202 includes an embedded license portion 204 and a content data portion 206. Content file 202 can be, for example, any one of content 128 of FIG. 1. Embedded license portion 204 can be situated in any of a variety of different locations in content file 202. For example, embedded license portion 204 could be included in a header of content file 202 or otherwise towards the beginning of content file 202. Alternatively, embedded license portion 204 could be included towards the end of content file 202, in the middle of content file 202, and so forth. Additionally, although portions 204 and 206 are each shown as a single portion, alternatively one or both of these portions could be separated. For example, embedded license portion 204 could be separated into multiple sub-portions that are distributed throughout content file 202, intermixing embedded license portion 204 and content data portion 206 in content file 202. In one or more embodiments, these sub-portions correspond to the single content data portion 206. In other embodiments, these sub-portions correspond to different parts of content data portion 206. For example, content data portion 206 can be separated into multiple parts with sub-portions of embedded license portion 204 being interspersed between these multiple parts. Following this example, a first sub-portion of embedded license portion 204 can correspond to a first part of the multiple parts (e.g., can include one or more licenses corresponding to just the content data in the first part), a second sub-portion of embedded license portion 204 can correspond to a second part of the multiple parts (e.g., can include one or more licenses corresponding to just the content data in the second part), and so forth.

Content data portion 206 includes the content data for content file 202, such as audio data for audio content, audio and video data for movie content, and so forth. As discussed above, part of content data portion 206 is encrypted using a cryptographic key. Embedded license portion 204 includes one or more embedded licenses for content file 202. Each of these licenses can be part of a chain of licenses or a standalone license, as discussed in more detail below.

Embedded license portion 204 stores one or more embedded licenses, and the particular licenses stored in portion 204 can change over time. In one or more embodiments, embedded license portion 204 is a static portion with a fixed amount of space that does not change regardless of the number of embedded licenses stored thereon. For example, embedded license portion 204 could be a fixed 10 kB space, although smaller or larger sizes can alternatively be used. This fixed space allows embedded licenses to be added and/or removed from portion 204 without affecting content data portion 206. For example, a new embedded license can be added to content data portion 206 by simply overwriting part of embedded license portion 204. The size of content file 202, and content data portion 206, are unchanged by adding such an additional embedded license.

In other embodiments, embedded license portion 204 is a variable amount of space. In such embodiments, the size of embedded license portion 204 can be increased to accommodate additional embedded licenses and/or decreased to accommodate fewer embedded licenses.

Situations can arise where it is desired to add one or more new embedded licenses to embedded license portion 204 but there is insufficient space for such a new embedded license. In such situations, one or more embedded licenses in portion 204 are deleted from portion 204 in order to accommodate the new license. In one or more embodiments such embedded licenses deleted from portion 204 are added to the license store of the device performing the deletion (e.g., license store 132 of FIG. 1) or alternatively another license store. Alternatively, such licenses can be deleted from portion 204 without being stored in such a license store or elsewhere.

Licenses can be selected for deletion from portion 204 in a variety of different manners. In one or more embodiments, a three-step process is used to select one or more licenses for deletion from portion 204. First, any license that has expired is selected for deletion. Licenses oftentimes have associated durations or expiration dates, and once expired can no longer be used to decrypt the associated content. Accordingly, any such expired licenses are selected for deletion first.

Second, if no expired licenses are in portion 204, or insufficient expired licenses are in portion 204 to make sufficient space for the one or more licenses to be added, then any license that cannot be used by the device adding the new license is deleted. Content can include embedded licenses usable by different devices and/or domains. If a license cannot be used by the device to decrypt the content, then such a license is selected for deletion. All such licenses that cannot be used by the device can be selected for deletion, or alternatively only enough licenses to make sufficient space for the one or more licenses to be added. If more licenses that cannot be used by the device are in embedded license portion 204 than need to be deleted to make sufficient space for the one or more licenses to be added, then particular ones of those licenses are selected for deletion. This selection can be made in different manners, such as based on an order in which licenses occur in portion 204 and/or are accessed in portion 204, based on an age (e.g., from the oldest to the newest) of the licenses (the age of a license can be determined in different manners, such as when the license was embedded in portion 204, when the license was created, and so forth), random selection, and so forth.

Third, if the first two steps do not make sufficient space for the one or more licenses to be added, then one or more remaining licenses in portion 204 are selected from the oldest to the newest. As above, the age of a license can be determined in different manners.

Following this three-step process, a sufficient quantity of licenses are selected for deletion, and deleted, from embedded license portion 204 to make sufficient space for one or more new embedded licenses. The deletion of a license from portion 204 can be accomplished in different manners, such as overwriting the license with a new license, overwriting the license with a particular bit pattern or other data, shortening the size of the used section of embedded license portion 204, and so forth.

Each license within embedded license portion 204 can be a standalone license or part of a chain of licenses. A standalone license is a license that includes both sufficient policy and a cryptographic key for the module implementing the DRM to determine whether the requested action can be performed with the corresponding content.

A license that is part of a chain of licenses, on the other hand, is used in conjunction with one or more additional licenses for the module implementing the DRM to determine whether the requested action can be performed with the corresponding content. One or more of these additional licenses can be included in portion 204, or alternatively can be in a separate license store (e.g., store 132 of FIG. 1). In one or more embodiments, the embedded license is a part of a chain of licenses referred to as a leaf license, and identifies a root license stored in a license store of the device (e.g., store 132 of FIG. 1) and/or included in embedded license portion 130.

For example, in FIG. 1 a leaf license can be embedded in particular content 128, the leaf license identifying a root license included in license store 132. The leaf license can include various policy, including a constraint that the identified root license is to be present in license store 132 (and/or embedded license portion 130) in order for a particular action to be carried out. If the identified root license is present in license store 132, then consumption module 122 can perform that particular action; otherwise, module 122 will not perform the action.

The separation of licenses into leaf and root licenses can have numerous benefits. For example, a user of target device 104 in a subscription-based environment may pay a monthly charge for access to content 128. All of the content 128 can include a leaf license identifying a particular root license that is to be present in order for the content to be played back. When the user pays his or her monthly fee, the root license in store 132 is updated to remain valid, whereas if the user does not pay his or her monthly fee then the root license in store 132 expires. Accordingly, each month only the root license is updated upon payment of the monthly fee, and the embedded licenses in the numerous content 128 need not be updated.

It should be noted that the chain of licenses can include two or more licenses. For example, a chain of licenses can be two licenses, such as a leaf license and a root license as discussed above. Additionally, the chain of licenses can include three or more licenses, such as one or more additional licenses being included in the chain of licenses in addition to the leaf license and the root license. For example, the leaf license can identify an intermediate license, which in turn can identify a root license. Such an intermediate license can be included in embedded license portion 130, or alternatively in a separate license store (e.g., store 132 of FIG. 1). Each intermediate license can include various policy, including a constraint that one or more identified licenses (e.g., one or more intermediate licenses, one or more root licenses, etc.) that are to be present in embedded license portion 130 (and/or another license store) in order for a particular action to be carried out.

In one or more embodiments employing chains of licenses, the cryptographic key for decrypting particular content 128 can be stored in different locations. For example, the cryptographic key can be included in an embedded leaf license (but is only usable if the identified root license and any other intermediate licenses in the chain of licenses is present). Following this example, the identified root license includes a root key encrypted with a public key of a particular device or domain. The device uses the private key of the device or the domain to decrypt the root key, and then uses the root key to decrypt the cryptographic key in the embedded leaf license. By way of another example, the cryptographic key can be included in the root license rather than in the embedded leaf license. By way of another example, the embedded leaf license may include one portion of the cryptographic key while the root license includes another portion of the cryptographic key.

Content data portion 206 can be encrypted in a variety of different manners, with different DRM systems using different encryption techniques. In one or more embodiments, content data portion 206 is encrypted using symmetric key cryptography. The shared key used to encrypt content data portion 206 is included in one or more licenses associated with content file 202, such as an embedded license stored in portion 204 and/or a root license stored in a license store (e.g., store 132 of FIG. 1). The shared key is encrypted using a public key for a particular device or a particular domain. That particular device, or any device in that particular domain, can in turn use its private key to decrypt the shared key, and then use the shared key to decrypt content data portion 206. Accordingly, only those devices having the appropriate private key can decrypt content data portion 206. Furthermore, whether the DRM system (e.g., as implemented by consumption module 122 of FIG. 1) will use its private key to decrypt the shared key is dependent on the policy in the one or more licenses for the content.

Alternatively, content data portion 206 can be encrypted in other manners. For example, content data portion 206 can be encrypted with a public key for a particular device or a particular domain. Accordingly, that particular device or any device in that particular domain can use its private key to decrypt content data portion 206. Whether the DRM system (e.g., as implemented by consumption module 122 of FIG. 1) will use its private key to decrypt content data portion 206 is dependent on the policy in the one or more licenses for the content.

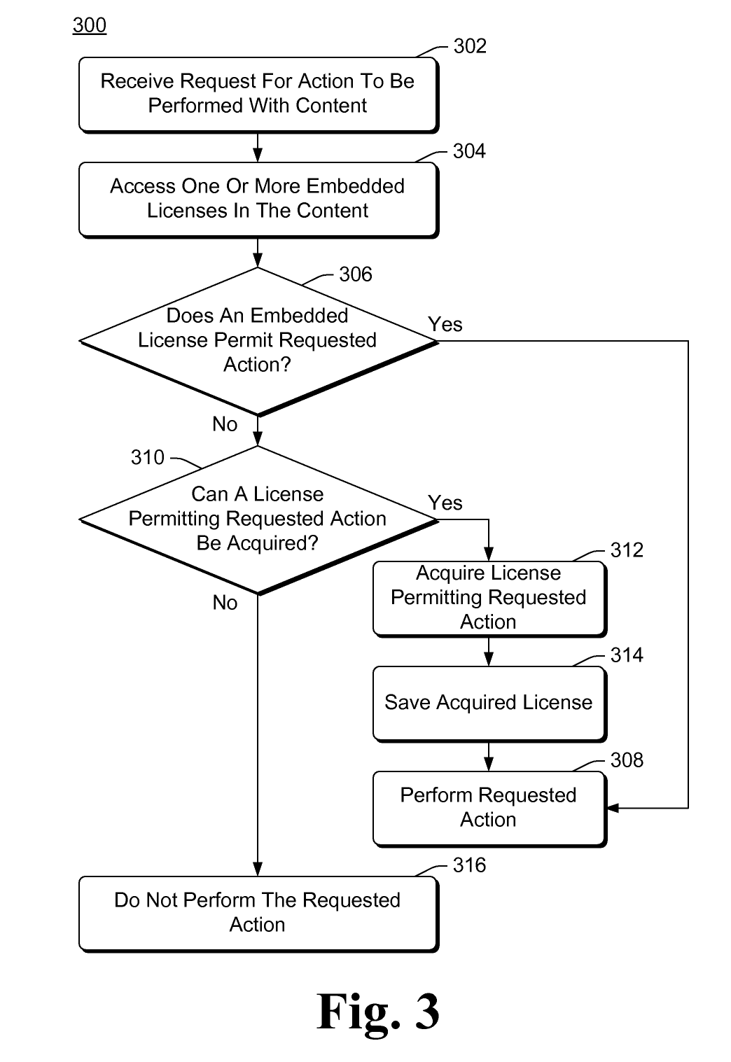

FIG. 3 is a flowchart illustrating an example process 300 for using content having embedded licenses. Process 300 is carried out by a device, such as target device 104 of FIG. 1, and can be implemented in software, firmware, hardware, or combinations thereof. Process 300 is typically performed by one or more modules responsible for implementing DRM in the device, such as consumption module 122 of FIG. 1. Process 300 is an example process for using content having embedded licenses; additional discussions of using content having embedded licenses are included herein with reference to different figures.

Initially, a request for an action to be performed with content is received (act 302). As discussed above, such an action can be playback of the content, transferring the content to another device, burning the content to a CD, printing a hard copy of the content, emailing the content, and so forth. One or more licenses embedded in the content for which the action is to be performed are then accessed (act 304), and a check is made as to whether one or more of the embedded licenses permits the requested action (act 306). An embedded license permits the requested action if the policy included in the embedded license indicates that the requested action can be performed.

If at least one of the embedded licenses in the content permits the requested action to be performed with the content, then the requested action is performed (act 308). Otherwise, a check is made as to whether a license permitting the requested action can be acquired (act 310). A license permitting the requested action can be acquired in a variety of different manners. For example, another device such as a server from which the content was received can be accessed to acquire a license, a service such as a content subscription service can be accessed to acquire the license, and so forth. Acquiring the license may require registering the device with a domain, or additional input from a user, such as approval to purchase the license, credit card or other purchasing information, identification of another license store where the license can be found, and so forth.

If a license permitting the requested action can be acquired, then such a license is acquired (act 312) and saved (act 314). As discussed in more detail below, saving the license can include embedding the license in the content and/or saving the license in a separate license store. The action requested in act 302 is also performed (act 308).

Returning to act 310, if a license permitting the requested action cannot be acquired, then the requested action is not performed (act 316).

It should be noted that the embedded license in acts 304 and 306, or the acquired license in acts 310-314, can be a standalone license or part of a chain of licenses. Additionally, such licenses can be licenses permitting a particular device implementing process 300 to perform the requested action, or alternatively licenses permitting a particular device implementing process 300 to perform the requested action when the particular device is a member of a particular domain.

Process 300 is discussed with reference to checking if a license permitting the requested action can be acquired in act 310 if an embedded license does not permit the requested action in act 306. Alternatively, one or more additional license stores can be accessed prior to performing the checking of act 310. For example, license store 132 of FIG. 1 can be accessed to see if a license in store 132 permits the requested action, and if so the requested action can be performed in act 308. By way of another example, another license store (not shown) can be accessed to see if a license in that license store permits the requested action, and if so the requested action can be performed in act 308.

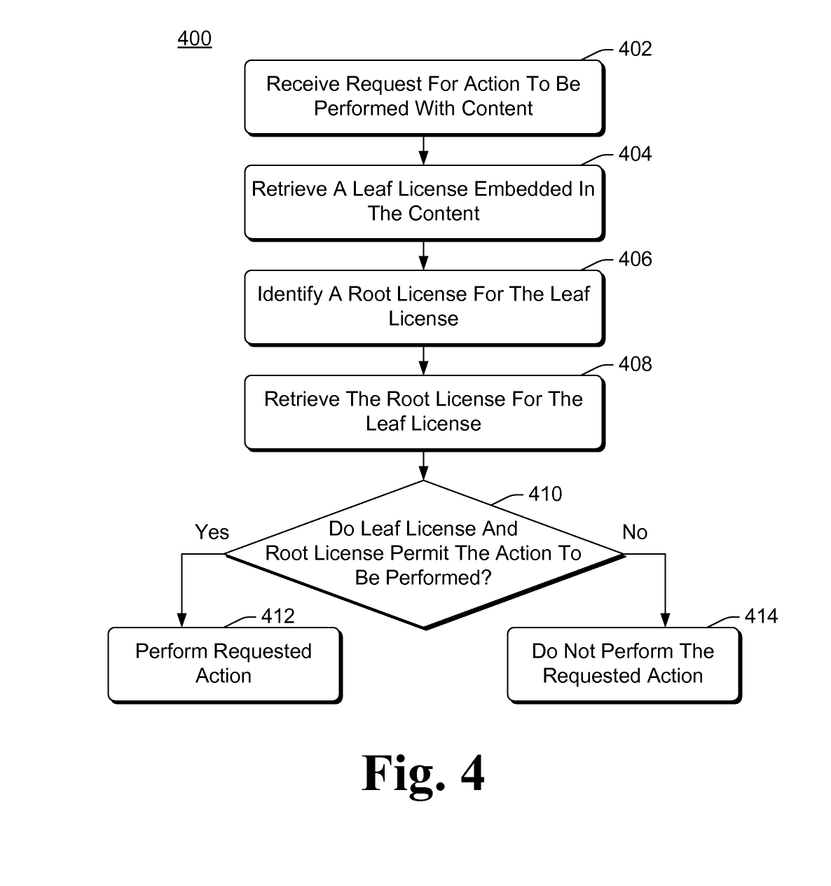

FIG. 4 is a flowchart illustrating an example process 400 for using chains of licenses. Process 400 is carried out by a device, such as target device 104 of FIG. 1, and can be implemented in software, firmware, hardware, or combinations thereof. Process 400 is typically performed by one or more modules responsible for implementing DRM in the device, such as consumption module 122 of FIG. 1. In one or more embodiments, acts 404-410 implement acts 304 and 306 of FIG. 3. Process 400 is an example process for using chains of licenses; additional discussions of using chains of licenses are included herein with reference to different figures.

Initially, a request for an action to be performed with content is received (act 402), analogous to act 302 of FIG. 3 discussed above. A leaf license embedded in the content for which the action is to be performed is then retrieved (act 404), and a root license for the leaf license is identified (act 406). In one or more embodiments, this root license is identified by the leaf license. This identification can be explicit, such as an alphanumeric identifier of the root license being included in the leaf license, or alternatively can be implicit, such as a naming convention being used for licenses that allows a correspondence between leaf and root licenses to be maintained.

The root license for the leaf license is retrieved (act 408). The root license can be retrieved from a local license store, such as license store 132 of FIG. 1, or alternatively elsewhere such as a license store on another device, an embedded license portion of the content for which the action is to be performed, and so forth. This license store can be identified by the leaf license, or alternatively can be known to the module implementing process 400.

A check is then made as to whether the leaf license and the root license permit the requested action (act 410). If the leaf and root licenses permit the requested action to be performed, then the requested action is performed (act 412). Otherwise, the requested action is not performed (act 414).

Process 400 is described with reference to a leaf license and a root license. It is to be appreciated that one or more additional licenses can also be included in the license chain that includes the leaf license and the root license. Each of these additional licenses are identified as part of act 406, following the chain of licenses from the leaf license to the root license. The check in act 410 is then a check as to whether all of the licenses in the license chain permit the requested action, with the requested action being performed if permitted by all the licenses in the license chain, and otherwise with the requested action not being performed.

Returning to FIG. 1, licenses can be embedded in content by source device 102, target device 104, and/or another device. The licenses embedded in content by device 102, device 104, and/or another device can be standalone licenses and/or parts of chains of licenses, as discussed above. Additionally, the licenses embedded in content by device 102, device 104, and/or another device can be licenses for device 102 and/or for a domain of which device 102 is a part.

In embodiments in which source device 102 embeds licenses in content, source device 102 includes a license embedding module 116 that embeds licenses in content prior to transferring the content to target device 104. In one or more embodiments, license embedding module 116 embeds leaf licenses in content 114. Module 116 can pre-embed leaf licenses in content 114 so that the content 114 already has the leaf license embedded when transfer of the content to target device 104 is requested, and/or embeds the leaf licenses in content 114 in response to a request for the content 114. As discussed above, the leaf licenses identify a root license, so the same leaf licenses can be embedded in content 114 for multiple different devices in multiple different domains. Although these leaf licenses are all the same, requested actions with the content are not performed on a device unless an appropriate root license is also available to the device as discussed above.

In embodiments in which target device 104 embeds licenses in content, target device 104 includes license embedding module 124 to embed the licenses in received content. License embedding module 124 can be implemented as part of consumption module 122, or alternatively can be a separate module operating in conjunction with and/or independently of consumption module 122. For example, consumption module 122 could communicate a request to license embedding module 124 to embed a license in particular content 128. By way of another example, license embedding module 124 can operate independently, searching content store 126 for content 128 and embedding a license from license store 132 into content 128 when content 128 without an embedded license is found.

When the content is received, a license is obtained from license store 132 or is otherwise acquired as needed (e.g., analogous to the discussion above regarding process 300 of FIG. 3). License embedding module 124 writes this license to the embedded license portion of a file including the content (e.g., embedded license portion 204 of FIG. 2), overwriting any licenses selected for deletion if space to store this license is needed. In one or more embodiments the license is embedded in the content when the content is acquired, although the license can alternatively be embedded at other times.

In embodiments in which another device other than source device 102 or target device 104 embeds licenses in content, the other device includes a license embedding module analogous to license embedding module 116. The licenses are embedded in the content, then the content can be transferred to or otherwise made available to source device 102. The licenses are thus pre-embedded in content 114, so that the content already has the leaf license embedded when transfer of the content to target device 104 is requested, and source device 102 need not embed the leaf license.

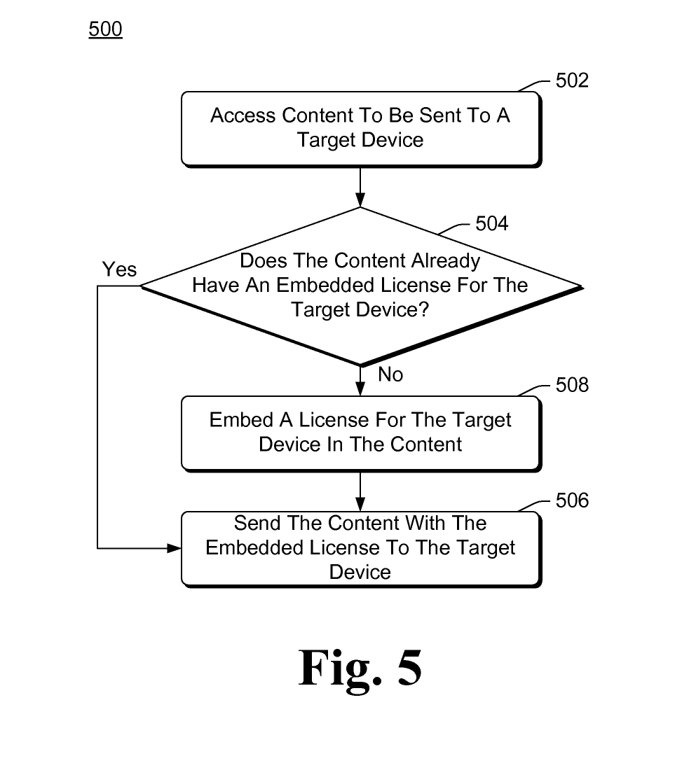

FIG. 5 is a flowchart illustrating an example process 500 for embedding licenses at a source device. Process 500 is carried out by a device, such as source device 102 of FIG. 1, and can be implemented in software, firmware, hardware, or combinations thereof. Process 500 is typically performed by a module of the source device, such as license embedding module 116 of FIG. 1. Process 500 is an example process for embedding licenses at a source device; additional discussions of embedding licenses at a source device are included herein with reference to different figures.

Initially, content to be sent to a target device is accessed (act 502). In one or more embodiments, this content is accessed in response to a request from the target device for the content. Alternatively, this content can be accessed in response to other inputs, such as a request from a user of the device implementing process 500, from another component or device, and so forth.

A check is then made as to whether the content already has an embedded license for the target device (act 504). As discussed above, this embedded license for the target device can be a standalone license and/or part of a chain of licenses, and can be a license for the target device and/or for a domain of which the target device is a part. If an embedded license for the target device is already embedded in the content, then the content with the embedded license is sent to the target device (act 506).

However, if no such embedded license is already present in the content, then a license for the target device is embedded in the content (act 508). As discussed above, this embedded license for the target device can be a standalone license and/or part of a chain of licenses, and can be a license for the target device and/or for a domain of which the target device is a part. Whether such a license is embedded in the content is also optionally dependent on other criteria, such as whether the target device is permitted to receive the content (e.g., an appropriate fee has been paid), and so forth. Once the license is embedded, the content with the embedded license is sent to the target device (act 506).

Returning to FIG. 1, situations can arise as discussed above in which a license is acquired by target device 104 from a license source device. This license source device can be source device 102 or alternatively another device (not shown). This license can be already embedded in content 128 or alternatively can be received separately. When such a license is received it can be stored in the content 128 to which it corresponds by embedding it in the content 128 to which it corresponds, stored in license store 132, stored in a different license store (not shown), and so forth.

In one or more embodiments, the received license includes one or more embedded license rules to target device 104 indicating where target device 104 is to store the license. Consumption module 122 or alternatively another module on target device 104 accesses these one or more rules and stores the license based on these one or more rules. These one or more rules can indicate that the license is to be stored (embedded) in one or more of the content 128 to which the license corresponds, license store 132, another license store on another device (not shown), and so forth. In one or more embodiments these one or more rules are merely suggestions regarding where to store the license. Alternatively, policy in the license may indicate that consumption module 122 or another module implementing the DRM at target device 104 is to follow the rules in order to access the content.

The rules can be included in a variety of different licenses, including a standalone license, part of a chain of licenses (e.g., a leaf license or a root license), a license for the target device, a license for a domain of which the target device is a part, and so forth. As the one or more rules are included in the license, they remain with the license whenever the license is stored or copied to another device. Alternatively, the one or more rules can be deleted from the license once the license has been stored based on the one or more rules.

Table I describes examples of one or more rules that can be included in a license. It is to be appreciated that these are only examples, and that in some embodiments none of these rules may be used, and in other embodiments different and/or additional can be used.

TABLE I

| Rule | Description |
|---|---|
| Ignore | The license is not to be embedded in the content, but can |
| | optionally be stored in the license store of the device. |
| Copy | The license is to be embedded in the content and also |
| | stored in the license store of the device. Alternatively, |
| | the license is to be stored in the license store of the |
| | device and subsequently embedded in the content |
| | when the content becomes available; the license is |
| | to be retained in the license store of the device |
| | after embedding the license in the content. |
| Move | The license is to be embedded in the content but not |
| | stored in the license store of the device. Alternatively, |
| | the license is to be stored in the license store of the |
| | device and subsequently embedded in the content |
| | when the content becomes available; the license |
| | can be removed from the license store of the |
| | device after embedding the license in the content. |
| License | Indicates that the license source will allow the target |
| Recoverable | device to recover the license if the target device |
| | loses the license. Where the license is stored is |
| | determined by the DRM on the target device keeping |
| | in mind that the license can be recovered from the |
| | license source if lost. |
| License | Indicates that the license source will not allow the target |
| Unrecoverable | device to recover the license if the target device loses the |
| | license. Where the license is stored is determined by the |
| | DRM on the target device keeping in mind that the |
| | license cannot be recovered from the license |
| | source if lost. |

It should be noted that in some situations storage of the license in one or more locations identified by a rule has already occurred. For example, assume a target device receives content having an embedded license that includes a copy rule. In this example the target device can store the license in the license store of the device when it is received, but the target device does not need to store the license in the content as the license is already embedded in the content.

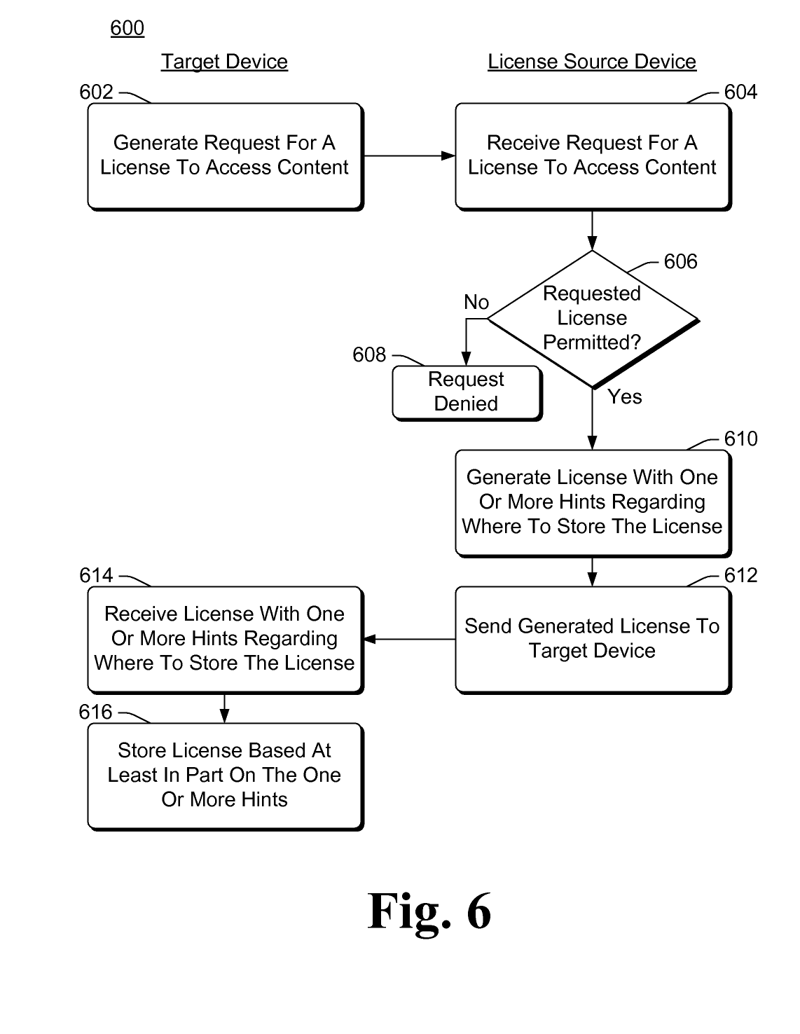

FIG. 6 is a flowchart illustrating an example process 600 for using embedded license rules. Process 600 can be implemented in software, firmware, hardware, or combinations thereof. Acts of process 600 illustrated on the left-hand side of FIG. 6 are carried out by a target device, such as target device 104 of FIG. 1. Acts of process 600 illustrated on the right-hand side of FIG. 6 are carried out by a license source device, such as source device 102 of FIG. 1. Process 600 is an example process for using license rules; additional discussions of using license rules are included herein with reference to different figures.

Initially, the target device generates a request for a license to access content (act 602). The license source device receives this request (act 604), and determines whether the requested license is permitted (act 606). This determination in act 606 can be made in a variety of different manners as discussed above, such as based on whether an appropriate fee has been paid, whether the target device from which the request is received is part of a domain permitted to receive the license, and so forth. If the target device is not permitted to have the requested license then the request is denied (act 608). This denial can optionally include returning an indication to the target device that the request has been denied.

However, if the target device is permitted to have the requested license, then a license with one or more rules regarding where to store the license is generated (act 610) and sent to the requesting target device (act 612). The target device receives the license with the one or more rules and stores the license based at least in part on the one or more rules in the received license (act 616). Any of a variety of different rules can be included in the license as discussed above.

Thus, it can be seen that the embedded licenses for content discussed herein can be used in a variety of different manners. By embedding the licenses, the content and corresponding license can be easily transferred among various devices, yet DRM is still applied to allow only those devices authorized by one or more licenses corresponding to particular content to access that particular content. Further, by embedding the licenses additional accesses to other devices can be avoided. For example, numerous songs (or other content) can be copied to a portable device such as a cell phone and played back based on the licenses embedded within those songs, alleviating the cell phone from the need to incur access time and charges to access a server in order to obtain licenses to play back the numerous songs.

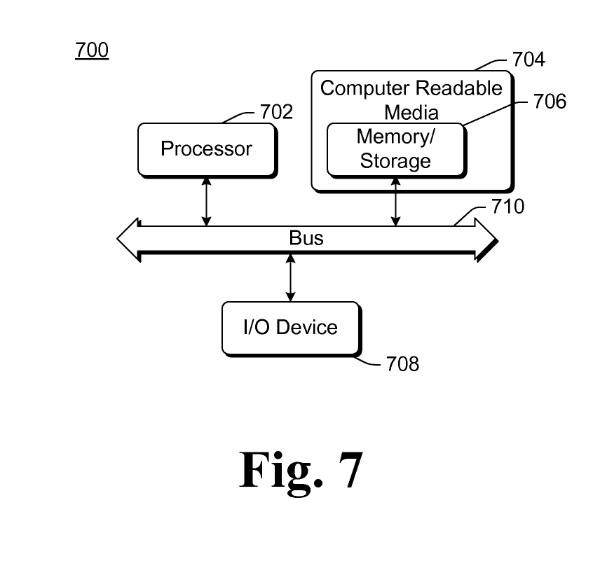

FIG. 7 illustrates an example computing device 700 that can be configured to implement the embedded licenses for content in accordance with one or more embodiments. Computing device 700 can be, for example, target device 104 or source device 102 of FIG. 1.

Computing device 700 includes one or more processors or processing units 702, one or more computer readable media 704 which can include one or more memory and/or storage components 706, one or more input/output (I/O) devices 708, and a bus 710 that allows the various components and devices to communicate with one another. Computer readable media 704 and/or I/O device(s) 708 can be included as part of, or alternatively may be coupled to, computing device 700. Bus 710 represents one or more of several types of bus structures, including a memory bus or memory controller, a peripheral bus, an accelerated graphics port, a processor or local bus, and so forth using a variety of different bus architectures. Bus 710 can include wired and/or wireless buses.

Memory/storage component 706 represents one or more computer storage media. Component 706 can include volatile media (such as random access memory (RAM)) and/or nonvolatile media (such as read only memory (ROM), Flash memory, optical disks, magnetic disks, and so forth). Component 706 can include fixed media (e.g., RAM, ROM, a fixed hard drive, etc.) as well as removable media (e.g., a Flash memory drive, a removable hard drive, an optical disk, and so forth).

The techniques discussed herein can be implemented in software, with instructions being executed by processing unit(s) 702. It is to be appreciated that different instructions can be stored in different components of computing device 700, such as in a processing unit 702, in various cache memories of a processing unit 702, in other cache memories of device 700 (not shown), on other computer readable media, and so forth. Additionally, it is to be appreciated that the location where instructions are stored in computing device 700 can change over time.

One or more input/output devices 708 allow a user to enter commands and information to computing device 700, and also allows information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embody computer readable instructions, data structures, program modules, or other data in a modulated data signal, such as carrier wave or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above are also included within the scope of computer readable media.

Generally, any of the functions or techniques described herein can be implemented using software, firmware, hardware (e.g., fixed logic circuitry), manual processing, or a combination of these implementations. The terms “module,” “functionality,” and “logic” as used herein generally represent software, firmware, hardware, or combinations thereof. In the case of a software implementation, the module, functionality, or logic represents program code that performs specified tasks when executed on a processor (e.g., CPU or CPUs). The program code can be stored in one or more computer readable memory devices, further description of which may be found with reference to FIG. 7. The features of the embedded licenses for content techniques described herein are platform-independent, meaning that the techniques can be implemented on a variety of commercial computing platforms having a variety of processors.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. One or more computer storage media having stored thereon multiple instructions that, when executed by one or more processors of a device, cause the one or more processors to:
receive a request to perform an action with content;
retrieve a license for the content, the license having been previously embedded in the content, and the license being for a domain that includes one or more devices including the device; and
allow the action to be performed with the content if the license indicates that the action with the content is permissible, and otherwise prevent the action from being performed with the content.

2. One or more computer storage media as recited in claim 1, wherein the instructions further cause the one or more processors to acquire a new license for the content and embed the license in an embedded license portion of a file including the content.

3. One or more computer storage media as recited in claim 2, wherein the instructions further cause the one or more processors to overwrite another license in the embedded license portion with the new license if there is insufficient space in the embedded license portion for the new license.

4. One or more computer storage media as recited in claim 1, wherein the instructions further cause the one or more processors to obtain a new license for the content and access a rule identified in the new license, the rule indicating whether to embed the new license in one or both of an embedded license portion of a file including the content and a license store of the device.

5. One or more computer storage media as recited in claim 1, wherein the license includes a policy identifying when it is permissible to decrypt the content, and a cryptographic key to be used to decrypt the content.

6. One or more computer storage media as recited in claim 1, wherein the instructions further cause the one or more processors to obtain one or more rules from the license and store the license based at least in part on the one or more rules.

7. One or more computer storage media as recited in claim 1, wherein the license comprises a leaf license, and wherein the instructions further cause the one or more processors to:
identify, based at least in part on the leaf license, a root license for the content;
retrieve the root license for the content from a license store; and
wherein to allow the action to be performed is to allow the action to be performed with the content only if both the leaf license and the root license indicate that the action with the content is permissible.

8. One or more computer storage media as recited in claim 7, wherein to retrieve the root license is to retrieve the root license from a license store on the device.

9. One or more computer storage media having stored thereon multiple instructions that, when executed by one or more processors of a device, cause the one or more processors to:
access content to be sent to a second device;
check whether the content already has an embedded license for a domain of which the second device is a part;
if the content already has the embedded license for the domain, then send the content with the embedded license to the second device; and
if the content does not already have the embedded license for the domain, then:
embed a license for the domain in the content; and
send the content with the embedded license to the second device.

10. One or more computer storage media as recited in claim 9, the embedded license comprising a leaf license that identifies a root license in a license store of the second device.

11. One or more computer storage media as recited in claim 10, the root license including a root key encrypted with a public key for the domain, wherein the root key can be used to decrypt a cryptographic key in the leaf license, and wherein the cryptographic key can be used to decrypt the content.

12. One or more computer storage media as recited in claim 9, the embedded license including a rule indicating where the second device is to store the embedded license.

13. One or more computer storage media as recited in claim 9, the embedded license including a policy identifying when it is permissible for the second device to decrypt the content, and a cryptographic key to be used by the second device to decrypt the content.

14. A method comprising:
receiving, from a device, a request for a license to access content; and
sending the requested license to the device, the requested license including one or more rules indicating where the device is to store the license.

15. A method as recited in claim 14, the one or more rules including an ignore rule indicating that the license is not to be embedded in the content but can be stored in a license store of the device.

16. A method as recited in claim 14, the one or more rules including a copy rule indicating that the license is to be embedded in the content and also stored in a license store of the device.

17. A method as recited in claim 14, the one or more rules including a move rule indicating that the license is to be stored in a license store of the device and subsequently embedded in the content when the content becomes available.

18. A method as recited in claim 14, the license including a policy identifying one or more actions that can be taken with the content, and a cryptographic key to be used by the device to decrypt the content.

19. A method as recited in claim 14, further comprising the device receiving the requested license and storing the requested license based at least in part on the one or more rules.

20. A method as recited in claim 14, the sending comprising sending the requested license embedded in the content.
